(19) United States
(12) Patent Application Publication
(10) Pub. No.: US 2007/0081515 A1
(43) Pub. Date: Apr. 12, 2007

(54) Integrated circuit and method for avoiding starvation of data

(75) Inventors: Johannus Theodorus Matheus Hubertus Dielissen, Eindhoven (NL); Edwin Rijpkema, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/577,741

(22) PCT Filed: Oct. 20, 2004
(86) PCT No.: PCT/IB04/52151

§ 371 Date: Apr. 26, 2006

(30) Foreign Application Priority Data
Oct. 31, 2003 (EP) 03104037.1

(51) Int. Cl. H04L 12/28

(52) U.S. Cl. 370/351

(57) ABSTRACT

The invention provides a router which can be deployed in a network on an integrated circuit. The router is capable of processing input data belonging to multiple traffic classes. The router can further guarantee, under admissible traffic, that all input data are processed and output adequately at an acceptable cost. The invention relies on the perception that the problem of contention is constituted by two more specific problems: input contention and output contention. The problem of input contention does not occur anymore, because the switch comprised in the router is designed such that it can serve multiple queues coupled to input ports simultaneously. The problem of starvation, caused by a continuous preference of high priority traffic to low priority traffic, is solved by allowing to serve queues containing data from low priority traffic classes simultaneously with queues containing data from high priority traffic classes.

The invention relates to an integrated circuit comprising a network, the network comprising a plurality of routers, at least one of the routers comprising a plurality of input ports arranged to receive input data corresponding to at least two traffic classes, the routers further comprising a plurality of queues, the queues being arranged to store input data corresponding to a single traffic class, wherein the input ports are coupled to at least two of the queues, the routers further comprising a switch.

The invention also relates to a method for avoiding starvation of data in an integrated circuit comprising a network, the network comprising a plurality of routers, at least one of the routers comprising a plurality of input ports receiving input data corresponding to at least two traffic classes, the routers further comprising a plurality of queues, wherein the queues store input data corresponding to a single traffic class, the input ports being coupled to at least two of the queues, the routers further comprising a switch.

Systems on silicon show a continuous increase in complexity due to the ever-increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach the processing system comprises a plurality of relatively independent, complex modules. In conventional processing systems the modules usually communicate to each other via a bus. As the number of modules increases however, this way of communication is no longer practical for the following reasons. First, the large number of modules forms a too high bus load. Second, the clock frequency decreases since many modules will be coupled to the bus. Third, the bus forms a communication bottleneck as it enables only one device to send data to the bus.

A communication network forms an effective way to overcome these disadvantages. The advantages of such a network have been described in the article “Trade Offs in the Design of a Router with Both Guaranteed and Best-Effort Services for Networks on Chip”, published at the Conference on Design, Automation and Test in Europe, 7 Mar. 2003, Munich (Germany). Among others, the network is able to structure and manage global interconnection wires, and to share such wires, thereby lowering their number and increasing their utilization.

The communication network comprises a plurality of partly connected nodes. Requests from a module are redirected by the nodes to one or more other nodes. Literature and current research show that these Networks on Chip become inevitable for large Systems on Chip. Such a network typically comprises routers which are interconnected by physical connections, such as wires.

A known architecture for the routers in a Network on Chip (NoC) is an input queued buffering architecture, because this architecture provides reasonable performance at a low cost. In traditional input queuing, a single queue is coupled to each input port of the router. The input data of the routers is categorized into traffic classes, which define the class of data to which the input data belongs. Traditional input queuing cannot make a difference between input data from different traffic classes, and therefore only a single traffic class is supported.

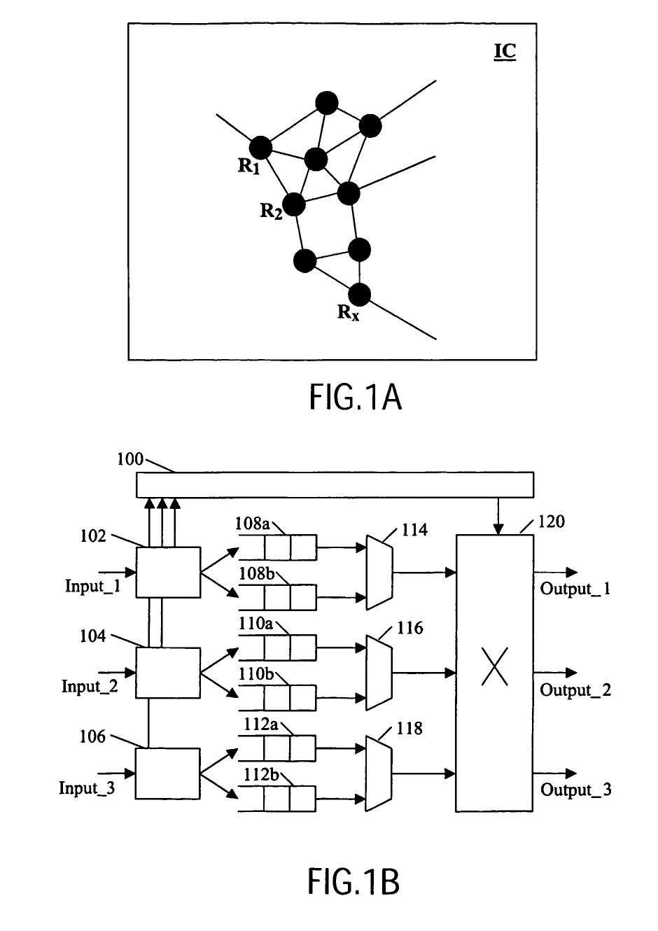

Systems which need multiple traffic classes can be implemented by multiple networks, but combining them into a single network has the advantage of sharing the physical connections which connect the routers. Therefore, it is desirable to have a single network which supports multiple traffic classes. The standard way to achieve this is to extend the input queuing scheme of the routers with multiple queues for each input port. Usually, the set of queues which is coupled to an input port is mapped onto one memory unit (for example a RAM memory), because one large memory has a higher area efficiency than multiple small memories. The standard architecture of a router which supports multiple traffic classes is illustrated in FIG. 1B.

The router makes decisions at discrete time points, which divide time in so-called ‘slots’. It is possible that a router attempts to send multiple data items over the same link (i.e. to the same output) in one slot; this problem is referred to as contention. Since only one data item can be sent over a link in a slot, a selection among the data items must be made; this process is referred to as contention resolution. Contention resolution is typically performed by scheduling the traffic; for example a scheduler may select data items corresponding to high priority traffic before selecting data items corresponding to low priority traffic. Scheduling is usually implemented by one or more arbiters, which are capable of granting and denying requests in a slot; only one request to an output port is granted per slot.

This standard architecture has two major problems. The first problem is that starvation can occur. Starvation means that some input data, for example data belonging to a low priority traffic class, is never served and hence that the input data is ‘stuck’ in the router. In fact, this means that data never arrives at its destination in the network. Two types of starvation can be distinguished. A first type of starvation is primarily caused by the network because more data items are assigned to an output port of the router than the bandwidth of the output port permits. Under these circumstances, the traffic for the output port is called ‘non-admissible traffic’. A second type of starvation is caused by the router itself, for example because contention resolution is not properly performed. In that case, the traffic for the output port is called ‘admissible traffic’. The invention relates to data items corresponding to admissible traffic; in the remainder of this document only admissible traffic is considered.

The second problem is related to the design of the arbiters, which have to schedule the access to the output ports. There is an arbiter for each output port. The arbiters have to perform contention resolution in the router. The design of these arbiters is relatively complex.

It is an object of the invention to provide a router which can be deployed in a network on an integrated circuit, the router being capable to process input data belonging to multiple traffic classes, and to guarantee under admissible traffic that all input data are processed and output adequately at an acceptable cost. This object is achieved by providing an integrated circuit, characterized by the characterizing part of claim 1. The object is also achieved by providing a method, characterized by the characterizing portion of claim 6.

The invention relies on the perception that the problem of contention is constituted by two more specific problems: input contention and output contention. Input contention occurs at an input port when multiple queues coupled to the input port contain data. Output contention occurs if multiple input ports try to access a single output port simultaneously (i.e. in one slot).

The known router architecture typically comprises multiplexers, which allow that at most one queue per input port is served in a slot, and a switch. The invention further relies on the perception that the multiplexers can be omitted, because it is possible to design a switch which can serve multiple queues coupled to input ports simultaneously. The problem of starvation, caused by a continuous preference of high priority traffic to low priority traffic, is solved by allowing to serve queues containing data from low priority traffic classes simultaneously with queues containing data from high priority traffic classes. The design of the arbiters can be simplified, since the problem of input contention does not exist anymore. The switch comprised in the router must be adapted to handle simultaneous input from multiple queues per input port, as will be explained in the description of the preferred embodiments.

An embodiment of the integrated circuit is defined in claim 2, wherein a first selection of the queues is arranged to store input data corresponding to a high priority traffic class, and a second selection of the queues is arranged to store input data corresponding to a low priority traffic classes. This embodiment has the advantage that high priority traffic and low priority traffic can be scheduled separately. Claim 3 defines a further embodiment, wherein the first selection is used to provide guaranteed communication services in the network. The second selection can be used to provide best-effort communication services in the network.

If the arbiters of at least one of the traffic classes (for example the arbiters of the high priority traffic class) implement a predetermined schedule, then contention-free transactions of the traffic between sources and destinations in the network can be achieved; this embodiment is defined in claim 4.

The embodiment defined in claim 5 provides a possible implementation of the switch according to the invention.

The present invention is described in more detail with reference to the drawings, in which:

FIG. 1A illustrates an integrated circuit comprising a network with routers;

FIG. 1B illustrates an architecture of a known router comprised in a network on an integrated circuit;

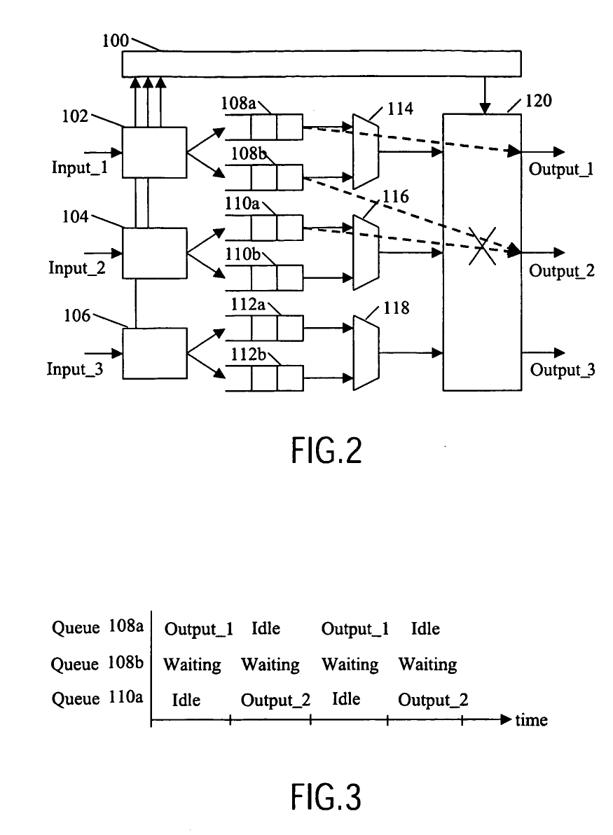

FIG. 2 illustrates the problem of starvation of input data belonging to multiple traffic classes in such an architecture;

FIG. 3 illustrates the status of several queues, which explains the problem of starvation as illustrated in FIG. 2;

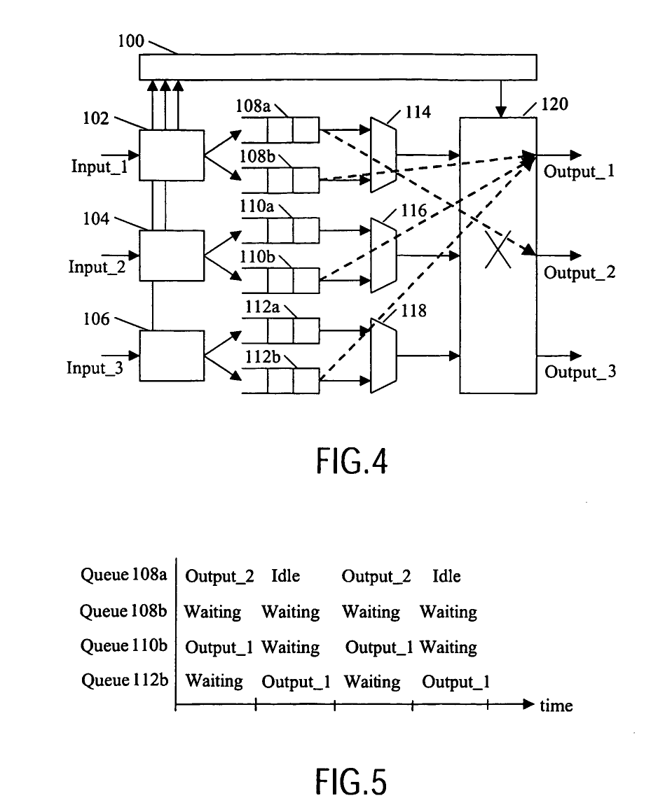

FIG. 4 illustrates an example of periodic retraction leading to starvation in the said architecture;

FIG. 5 illustrates the status of several queues, which explains the problem of starvation as illustrated in FIG. 4;

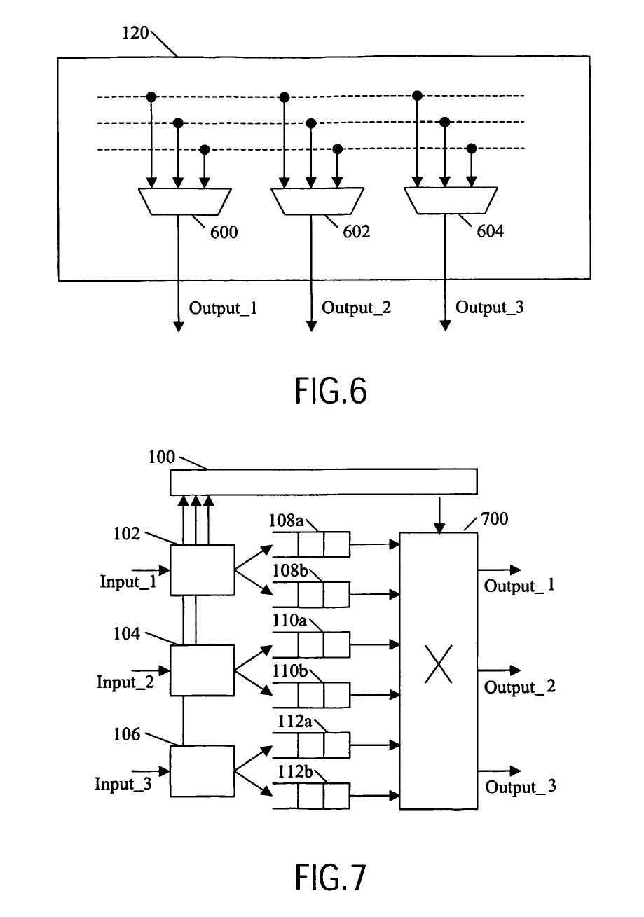

FIG. 6 illustrates an implementation of a switch in such an architecture;

FIG. 7 illustrates an architecture of a router in a network on an integrated circuit according to the invention;

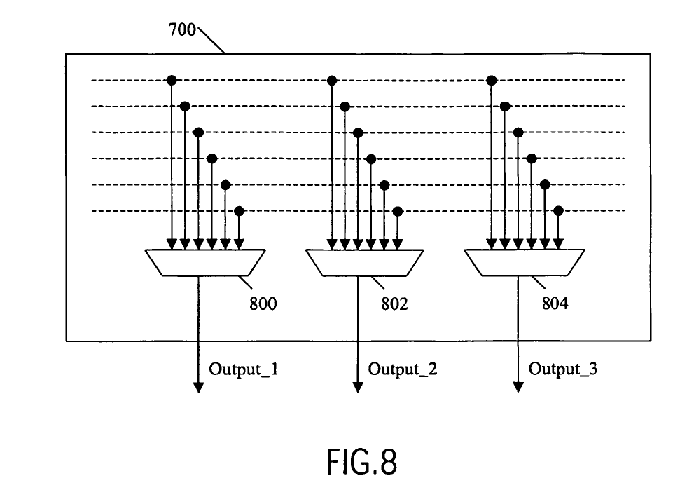

FIG. 8 illustrates an implementation of a switch according to the invention.

FIG. 1A illustrates an known integrated circuit IC comprising a network with routers R₁, R₂ up to and including Rₓ. The routers R₁, R₂ up to and including Rₓ are arranged to route data through the network. The input data of the routers R₁, R₂ up to and including Rₓ is categorized into traffic classes, which define the class of data to which the input data belongs. The invention relates to routers which are capable of routing data belonging to multiple traffic classes. As will be recognized by persons skilled in the art, the network may be extended to one or more other integrated circuits, so that the integrated circuit IC and the other integrated circuits share a single network. In that case the NoC spans multiple chips. The invention also relates to routers in such a shared network.

FIG. 1B illustrates an architecture of a router comprised in a network on an integrated circuit. In this example, the router comprises a controller 100 which is coupled to a number of input ports 102, 104, 106 and to a switch 120, also referred to as a crossbar switch. Note that alternative architectures are possible. The input ports 102, 104, 106 receive input data Input_1, Input_2, Input_3 which belong to multiple traffic classes; these input data are passed on to queues 108a, 108b, 110a, 110b, 112a, 112b. Each queue 108a, 108b, 110a, 110b, 112a, 112b is capable of storing input data Input_1, Input_2, Input_3 which belongs to a single traffic class. Hence, each input port is coupled to a number of queues; the number of queues depends on how many traffic classes are supported. In the given embodiment there are two queues per input port, for example queues 108a and 108b corresponding to input port 102, which means that input data belonging to two traffic classes is supported. It should be clear that other embodiments are possible as well, and depending on the number of traffic classes that should be supported, the number of queues per input port will be different.

The router also comprises a plurality of multiplexers 114, 116, 118 which allows that per unit of time (slot) at most one queue per input port is served. In general, the multiplexers 114, 116, 118 also have a connection (not shown) to the controller 100. The controller 100 comprises a plurality of arbiters (not shown) which implement the scheduling scheme and it calculates the settings of switches, for example.

f multiple queues at a single input port contain data, then there is input contention at that input port. Similarly, output contention occurs when multiple input ports try to access a single output port. The switch 102 which is used in this architecture is arranged to receive the input data Input_1, Input_2, Input_3 stored temporarily in the queues, under the constraint that at most one queue per input port is served in a unit of time (slot). In the example the switch 102 can receive data from at most three queues simultaneously, but it can never receive data from two queues coupled to the same input port simultaneously. The switch 102 then delivers the data as output data Output_1, Output_2, Output_3, to be processed further by the network.

FIG. 2 illustrates the problem of starvation of input data belonging to multiple traffic classes in an architecture as illustrated in FIG. 1. Starvation is a major problem in a network. In this example, the upper queues 108a, 110a, 112a coupled to the input ports 102, 104, 106 contain data belonging to a high priority traffic class, and the lower queues 108b, 110b, 112b coupled to the input ports 102, 104, 106 contain data belonging to a low priority traffic class. The dashed arrows in FIG. 2 represent requests to get access to specific output ports (not shown) of the switch 120. In other words, the input data stored temporarily in queue 108b would be redirected to the second output port of the switch 120 and output as output data Output_2. However, it turns out that the request from queue 108b to the second output port of the switch 120 can never be granted, as illustrated in FIG. 3. FIG. 3 illustrates the status of the queues 108a, 108b, 110a. While queues 108a and 110a (containing data belonging to a high priority traffic class) are granted access to the output ports during the even and odd slots respectively, queue 108b is not served because:
it cannot be served simultaneously with queue 108a because the multiplexer 114 imposes the constraint that only one of queues 108a, 108b can be served at a time;
it cannot be served simultaneously with queue 110a because queue 110a ‘occupies’ the output port to which queue 108b requests access, and queue 110a contains data from a higher priority traffic class.

If the pattern described above which occurs during even and odd slots is repeated endlessly, then queue 108b is never served and there is starvation of data.

Several attempts to overcome this problem have been undertaken, in particular in the form of arbitration schemes deployed by arbiters, all of which have not resulted in a real solution. Furthermore, the schemes are more difficult to implement and lead to complex hardware designs. Typically, these schemes also degenerate the performance of low priority traffic.

The following arbitration schemes are discussed hereinafter:
retraction of requests;
locking requests;
randomized arbitration;
multi-level prioritization.

The first known arbitration scheme uses a method referred to as retraction of requests. This means that a request to access an output port, from a queue which contains input data belonging to a low priority traffic class (also referred to as a low priority request), is retracted if a request occurs either from the same input port or to the same output port, provided that the data from that input port or the data to be sent to the output port belong to a high priority traffic class (also referred to as a high priority request). This method has low hardware cost, but the low priority arbiter (which schedules low priority requests) can only start after the high priority arbiter (which schedules high priority requests) has finished. This leads to a higher computational latency. Furthermore, this arbitration scheme is not fair and can even result in periodic retraction of low priority requests of a single queue. Again, there may be starvation on that queue.

An example of periodic retraction leading to starvation on a queue is given in FIG. 4 and FIG. 5. The input data Input_1 from the first input port 102 which belong to a low priority traffic class are directed to queue 108b, whereas the input data Input_1 which belong to a high priority traffic class are directed to queue 108a. Queues 110b and 112b contain input data Input_2, respectively Input_3, which belong to a low priority traffic class. It can be seen from FIG. 5 that queue 108b is not served because:
it cannot be served simultaneously with queue 108a because the multiplexer 114 imposes the constraint that only one of queues 108a, 108b can be served at a time;
The low priority request from queue 108b is retracted because queue 108a corresponds to the same input port;
The scheduler may serve queues 110b, 112b after retraction, but if queue 108b needs to be served again, there are again high priority requests from queue 108a, so the low priority request from queue 108b is retracted again, etc.

Another arbitration scheme uses a method referred to as locking requests. To avoid the long latency of retraction of requests, and to avoid periodic retraction, this method schedules high and low priority traffic classes simultaneously with taking only output contention into account. If there is input contention between a granted low priority request and a high priority request at a certain input port, then the grant of the low priority request is ignored and the low priority arbiter is locked to first grant the low priority that has just been ignored before granting any other low priority request. If this arbitration scheme were used in the example shown in FIG. 4, then the locking would in addition to the starvation of queue 108b also lead to the starvation of queues 110b and 112b if they ever address the output port containing output data Output_2. This means that the low priority requests are not served efficiently, and the utilization of the low priority bandwidth is far from optimal.

A further arbitration scheme consists of the retraction of requests, as explained above, combined with the use of a randomized arbiter. The randomized arbiter randomly grants one of the ‘contending requests’ (the requests which address the same output port) per output port. In this manner, the periodic retraction problem is solved by the randomization. However, the disadvantage of this arbitration scheme is that the implementation of a randomized arbiter is relatively expensive.

Finally, there is an arbitration scheme which uses a method referred to as multi-level prioritization in the remainder of this document. This method provides for priorities within the low priority traffic class, combined with the retraction of requests as explained above. If a request is retracted, its priority is incremented so that its chances to be granted increase as well. The arbiter for the low priority traffic class then needs to be a prioritized arbiter. However, also this arbitration scheme has the disadvantage that the hardware complexity and its cost are relatively high due to the prioritized arbiter and the management of priorities.

The routers known from the prior art deploy a switch 120 which is illustrated In FIG. 6. In this example a 3×3 crossbar switch is deployed. The switch 120 has three input lines, representing the output of the multiplexers 114, 116, 118. The switch 120 itself also comprises three multiplexers 600, 602, 604. Data is sent via each input line to multiplexers 600, 602, 604 according to the output port that is addressed. Multiplexer 600 accepts data for the first output port to be output as output data Output_1, multiplexer 602 accepts data for the second output port to be output as output data Output_2, and multiplexer 604 accepts data for the third output port to be output as output data Output_3. The switch operates as follows. For example, input data Input_3 belonging to a high priority traffic class is directed to queue 112a via input port 106. Let's assume that queue 112a requests access to the output port with output data Output_2. Then multiplexer 118 first multiplexes the data, and then the data enters the switch 120 via the lower input line. Subsequently, multiplexer 602 multiplexes the data and finally the data is output as output data Output_2.

As a consequence, the controller 100 can be simplified because the input contention does not occur anymore and the scheduling scheme is less complex. The prior art router also has the problem of continuous ‘head-of-line blocking’; the consequence is that starvation of data at the head of a queue at an input port results in starvation of all data at that input port. In the router according to the invention, head-of-line blocking does not occur endlessly and it occurs less frequently than in the prior art router, which also has a positive effect on the performance of the router.

In an embodiment, the difference between high priority traffic classes and low priority traffic classes can be used advantageously to provide a router which is capable of providing guaranteed services on the one hand and best-effort services on the other hand. Such a combined router architecture has been described in the article “Trade Offs in the Design of a Router with Both Guaranteed and Best-Effort Services for Networks on Chip”, published at the Conference on Design, Automation and Test in Europe, 7 Mar. 2003, Munich (Germany). Data which should be transferred through the network, the transfer of which having requirements such as guaranteed throughput and guaranteed latency, can then be classified as high priority traffic. Low priority traffic is a suitable class for data of which the transfer is performed on a best-effort basis. If a method referred to as static scheduling is deployed, i.e. a predetermined arbitration scheme, then contention-free transactions of high priority traffic between sources and destinations in a network can be achieved. In that case connections are set up between sources and destinations at compile-time instead of at run-time; these connections are set up to provide guaranteed services.

FIG. 7 illustrates an architecture of a router in a network on an integrated circuit according to the invention. The constraint from the prior art, i.e. the condition that per input port 102, 104, 106 only one of the queues 108a, 108b, 110a, 110b, 112a, 112b can be used at a time, is removed. This is achieved by coupling every queue 108a, 108b, 110a, 110b, 112a, 112b directly to the switch 700. In other words, the multiplexers 114, 116, 118 can be dispensed with. In this manner the architecture does not suffer from input contention at all. The switch 700 according to the invention must be adapted to make this possible, as is shown in FIG. 8. The switch 700 is a 6×3 crossbar switch, capable of receiving data from six input lines instead of three input lines (as was the case in the embodiment of FIG. 6). Again, the switch 700 comprises three multiplexers 800, 802, 804. These multiplexers 800, 802, 804 are arranged to receive input from six input lines, wherein each input line corresponds to data from one of the queues 108a, 108b, 110a, 110b, 112a, 112b. Hence, the switch 700 is arranged to receive input from all queues 108a, 108b, 110a, 110b, 112a, 112b simultaneously.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. An integrated circuit comprising a network, the network comprising a plurality of routers at least one of the routers comprising a plurality of input ports arranged to receive input data corresponding to at least two traffic classes, the routers further comprising a plurality of queues the queues being arranged to store input data corresponding to a single traffic class, wherein the input ports are coupled to at least two of the queues, the routers further comprising a switch characterized in that the switch is arranged to receive input from the plurality of queues simultaneously.

2. An integrated circuit as claimed in claim 1, wherein a first selection of the queues is arranged to store input data corresponding to a high priority traffic class, and wherein a second selection of the queues is arranged to store input data corresponding to a low priority traffic class.

3. An integrated circuit has claimed in claim 2, wherein the first selection is deployed to provide guaranteed communication services in the network, and wherein the second selection is deployed to provide best-effort communication services in the network.

4. An integrated circuit as claimed in claim 1, further comprising a controller which is coupled to the input ports and coupled to the switch the controller comprising a plurality of arbiters, wherein the arbiters of at least one of the traffic classes implement a predetermined schedule.

5. An integrated circuit as claimed in claim 1, wherein the switch comprises a plurality of multiplexers, each multiplexer being coupled to an output port, and each one of the multiplexers being arranged to accept as input the input data stored in the queues.

6. A method for avoiding starvation of data in an integrated circuit comprising a network, the network comprising a plurality of routers at least one of the routers comprising a plurality of input ports receiving input data corresponding to at least two traffic classes, the routers further comprising a plurality of queues wherein the queues store input data corresponding to a single traffic class, the input ports being coupled to at least two of the queues, the routers further comprising a switch, characterized in that the switch receives input from the plurality of queues simultaneously.
